(19) United States
(12) Patent Application Publication
(10) Pub. No.: US 2015/0371197 A1
(43) Pub. Date: Dec. 24, 2015

(54) SYSTEM AND METHOD TO DETERMINE APPOINTMENT DATES

(71) Applicant: CEQUITY LLC, Spring Valley, NY (US)

(72) Inventor: Yakov Z. MERMELSTEIN, Spring Valley, NY (US)

(73) Assignee: CEQUITY LLC, Spring Valley, NY (US)

(21) Appl. No.: 14/745,737

(22) Filed: Jun. 22, 2015

Related U.S. Application Data
(60) Provisional application No. 62/015,449, filed on Jun. 22, 2014.

(51) Int. Cl. G06Q 10/10

(52) U.S. Cl. CPC G06Q 10/1095

(57) ABSTRACT

A first participant having a scheduled meeting time slot with a service provider may exchange meeting time slots with other participants should the first participant be unable to attend the scheduled meeting time slot. Electronic calendars are monitored to allow for automatic, computerized exchange of meeting time slots. Participant-defined priorities and location information are taken into account to facilitate meeting time slot exchange.

### CROSS-REFERENCE TO RELATED PATENT APPLICATION

This patent application claims a benefit to the filing date of U.S. Provisional Patent Application Ser. No. 62/015,449 that is titled “Method of Determining Appointment Dates” and was filed on Jun. 22, 2014. The disclosure of U.S. 62/015,449 is incorporated by reference herein in its entirety.

### BACKGROUND

1. Field of the Invention

This invention relates to the electronics and communications industry and, more particularly, to a system and method for automatically searching electronic calendars to identify a time slot for a meeting between two persons.

2. Description of Related Technology

As technology becomes more sophisticated and accessible, more and more software products have become available. These products facilitate many different kinds of procedures and functions for their users.

One useful product that is becoming ubiquitous is electronic calendars. Unlike their paper counterparts, these electronic calendars perform many useful functions for their users. They include reminders, alarms, search functions and many other features.

An aspect of these calendars that is missing is the ability to automatically exchange time slots for people. Thus, there is a need in the industry for a method that automatically searches electronic calendars to facilitate two people exchanging the time slots they have for meeting with a common person. While an administrative assistant may identify alternative times and alternative service providers for a person requiring such services, a manual system is not effective. Locating alternative times and alternative service providers is a time consuming endeavor. By the time a viable alternative is located, the schedule of the person requiring the service may have changed rendering the alternative useless. Second, the administrative assistant may know where the person should be at a given time, however, the person may be far from that location such that the alternative selection is not useful. There remains a need for an automated system that does not suffer from the deficiencies of a manual system.

### SUMMARY OF THE DISCLOSURE

These and other objects of the invention are achieved by a method that involves automatically searching electronic calendars to facilitate exchanging meetings that two people have with the same person or entity.

In some embodiments, the present disclosure is directed to an electronic method of exchanging meeting time slots, comprising the steps of establishing electronic accessibility to an electronic calendar maintained at an universally accessible electronic location, the electronic calendar including date, time, and participants for each meeting time slot, wherein each of a plurality of first participants and each of a plurality of third participants have scheduled meeting time slots with at least one second participant, determining that a first participant has a need to exchange a scheduled meeting time slot, identifying a third participant that can use the first participant's scheduled meeting time slot, determining if the first participant can use a scheduled meeting time slot of the third participant, electronically exchanging the scheduled meeting time slot of the first participant and the scheduled meeting time slot of the third participants, and electronically updating an electronic calendar to reflect the electronic exchange of meeting time slots. In some embodiments, the step of determining a first participant has a need to exchange a meeting time slot includes the step of providing by the first participant a priority rating for at least one other meeting time slot. In some embodiments, the step of identifying a third participant that can use the first participant's scheduled meeting time slot includes the step of providing by the third participant a priority rating for at least one other meeting time slot.

In some embodiments, the second participant is a plurality of service providers providing the same type of services. In some embodiments, the step of determining that a first participant has a need to exchange a scheduled meeting time slot includes the step of requesting by the first participant a new meeting time slot. In some embodiments, the step of determining that a first participant has a need to exchange a scheduled meeting time slot includes the step of identifying a location of the first participant, wherein the location is a distance from a meeting location preventing the first participant from attending the meeting.

In some embodiments, location is determined by at least one of a global positioning system and entries in the electronic calendar of the first participant. In some embodiments, the electronic method of exchanging meeting time slots further comprises the step of providing the third participant with an option to electronically exchange the scheduled meeting time slot of the third participant with the scheduled meeting time slot of the first participant. In some embodiments, the electronic method of exchanging meeting time slots further comprises the step of providing the first participant with an option to electronically exchange the scheduled meeting time slot of the third participant with the scheduled meeting time slot of the first participant. In some embodiments, the electronic method of exchanging meeting time slots further comprises the step of alerting the second participant of the electronic exchange. In some embodiments, the electronic method of exchanging meeting time slots further comprises the step of providing a security module that enables a participant to interact with and exchange scheduled meeting time slots with other participants without providing identification information to the other participants.

In some embodiments, the present disclosure is directed an electronic method for scheduling meeting time slots, comprising the steps of establishing electronic accessibility to an electronic calendar maintained at an universally accessible electronic location, the electronic calendar including date, time, and participants for each meeting time slot, placing a participant on an electronic waiting list for meeting time slots with service providers offering specified services, monitoring meeting time slots of service providers to identify available meeting time slots, determining if the participant can use one of the available meeting time slots, electronically scheduling a meeting between the participant and a service provider in the available meeting time slots, and electronically updating the electronic calendar regarding scheduled meetings of the participant and service provider.

In some embodiments, the step of determining if the participant can use one of the available meeting time slots includes the step of analyzing at least one preference of the participant. In some embodiments, the at least one preference includes dates, times, days of the week, price, location, service quality, recommendations, or past experiences. In some embodiments, the step of electronically scheduling a meeting between the participant and a service provider in the available meeting time slots includes the step of automatically immediately booking a meeting time slot if the participant can use the meeting time slot.

Other objects, features and advantages of the present invention will become apparent upon reading the following detailed description in conjunction with the drawings and the claims.

### BRIEF DESCRIPTION OF THE DRAWINGS

For a better understanding of the invention, its operation and specific objects attained by its uses, reference should be had to accompanying drawings and descriptive matter in which there are illustrated preferred embodiments of the invention. The invention is described in connection with certain preferred embodiments with reference to the following illustrative figures.

FIG. 1 is a flowchart showing a method of exchanging meeting time consistent with some embodiments of the present disclosure.

FIG. 2 is a flowchart showing a method for scheduling meeting time slots consistent with some embodiments of the present disclosure.

FIG. 3 portrays a further embodiment of the method shown in FIG. 1.

FIG. 4 portrays a further embodiment of the method shown in FIG. 1.

FIG. 5 portrays a further embodiment of the method shown in FIG. 1.

FIG. 6 portrays a further embodiment of the method shown in FIG. 1.

FIG. 7 portrays a further embodiment of the method shown in FIG. 1.

FIG. 8 portrays a further embodiment of the method shown in FIG. 2.

FIG. 9 portrays a further embodiment of the method shown in FIG. 2.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

For purposes of the invention, the term electronic device includes any device that may be used for facilitating or affecting an electronic calendar. Applications and software, include, but are not limited to, mobile devices, cell phones, smart phones, hand-held computers, laptop computers, palm top computers, personal digital assistants (PDA), electronic pads and/or tablets, desktop computers, digital cameras, televisions and monitors and screens.

Calendaring software (or Applications) is software that provides users with an electronic version of a calendar. This software may provide an appointment book, address book, and/or contact list. These tools are an extension of many of the features provided by time management software, such as desk accessory packages and computer office automation systems. Calendaring is a standard feature of many PDAs, electronic digital assistants (EDAs), and smartphones. They are typically known as electronic calendars or just e-calendars.

The Invention, in its basic form, involves automatically searching electronic calendars to facilitate exchanging meetings that two people have with the same person. The underlying concept involves a person having a meeting with a person, but he needs to change the time and/or date. Typically he would have to cancel his meeting and then start the process over in order to schedule a new meeting. The advantage of the herein invention is that, instead of canceling and starting over to schedule, he can exchange meeting times and/or dates with someone who also has a meeting with that same person or entity. As used herein, the terms time slot, meeting time slot, meeting time, and the like are used interchangeably.

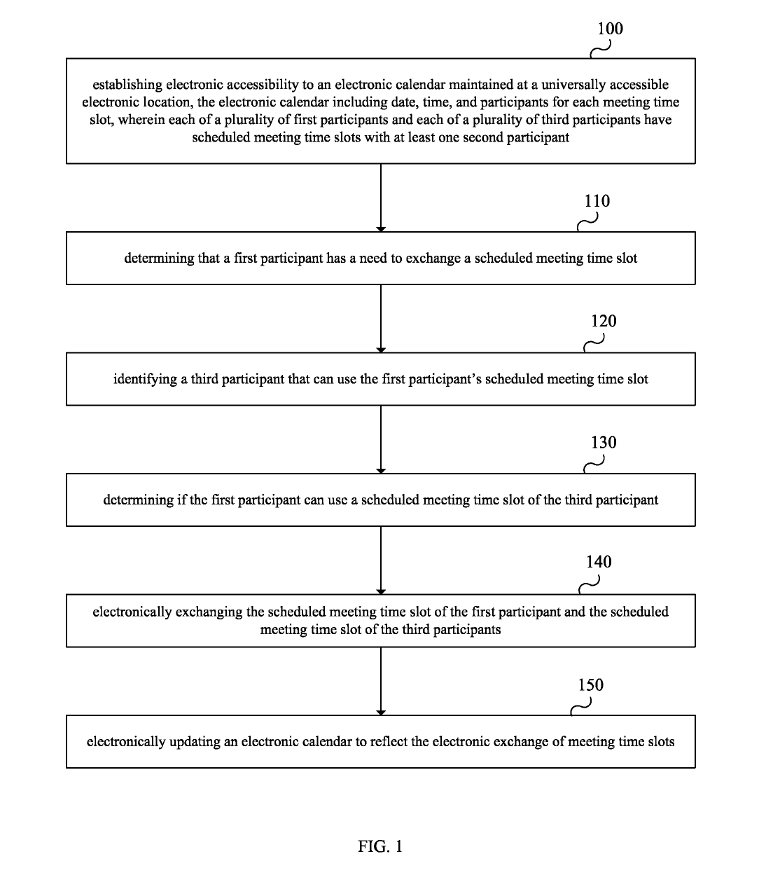

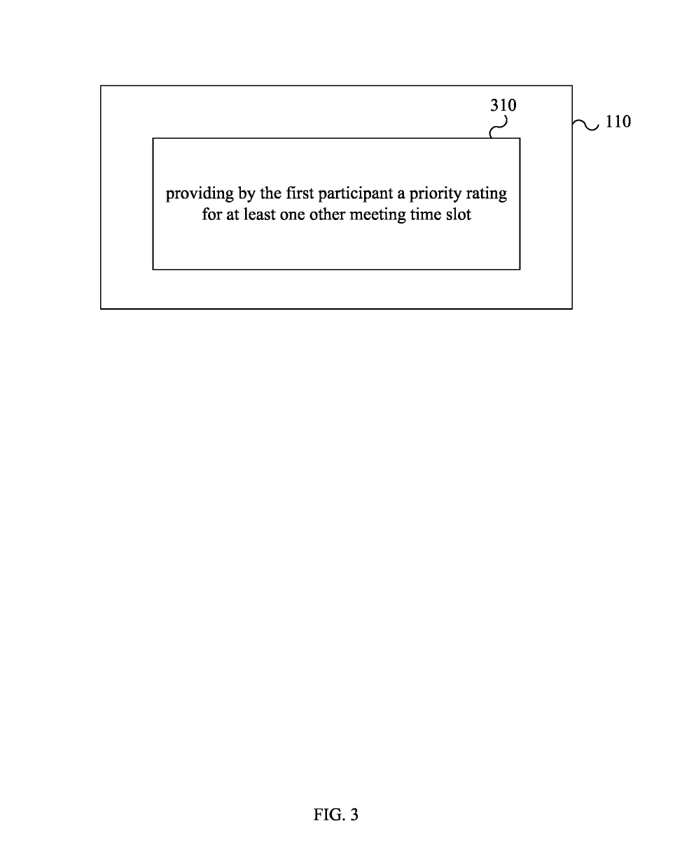

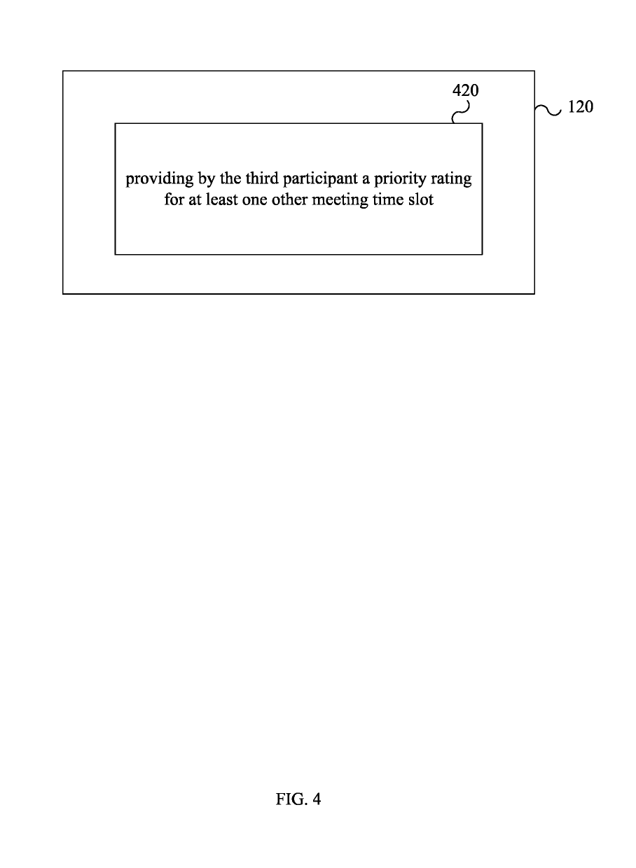

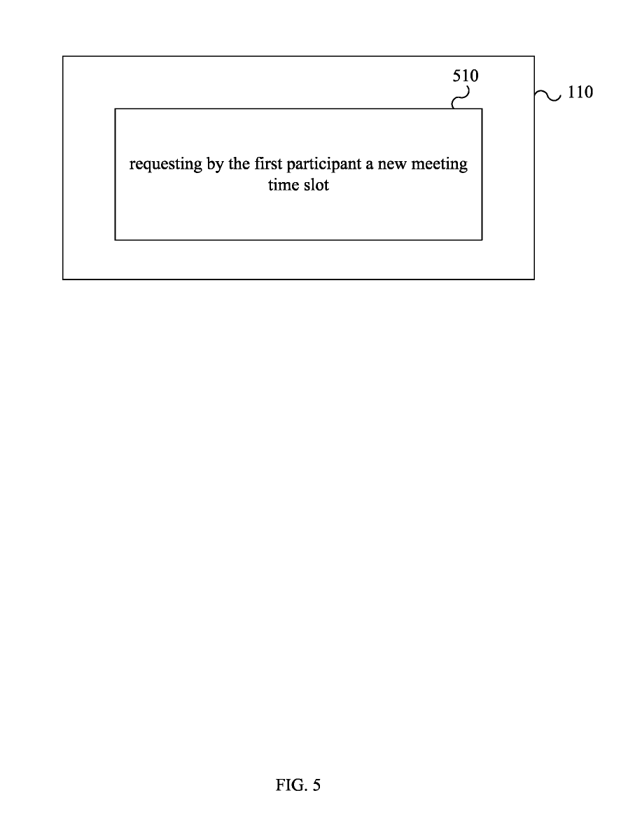

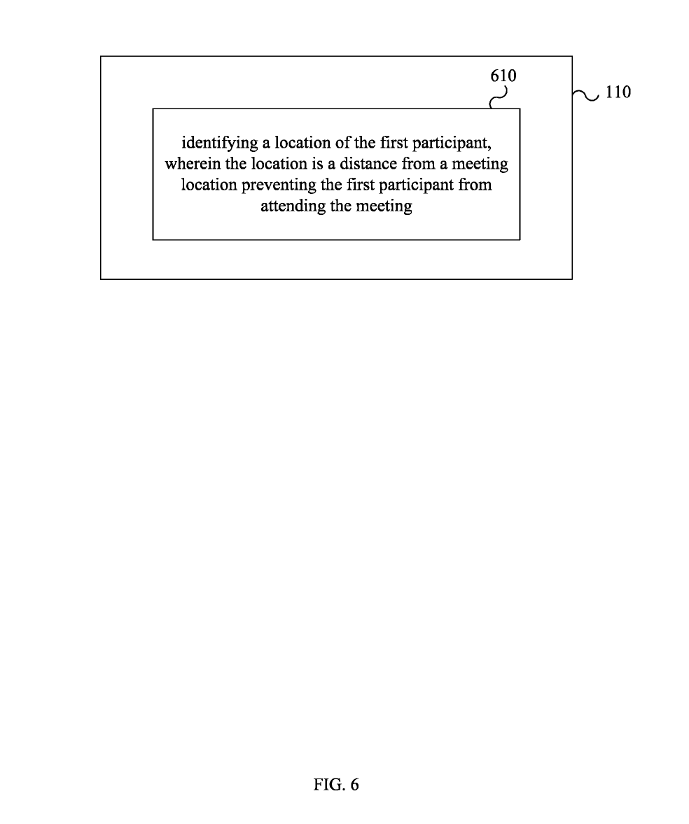

As shown in FIG. 1, in some embodiments, the present disclosure is directed to an electronic method of exchanging meeting time slots, comprising the steps of establishing 100 electronic accessibility to an electronic calendar maintained at an universally accessible electronic location, the electronic calendar including date, time, and participants for each meeting time slot, wherein each of a plurality of first participants and each of a plurality of third participants have scheduled meeting time slots with at least one second participant, determining 110 that a first participant has a need to exchange a scheduled meeting time slot, identifying 120 a third participant that can use the first participant's scheduled meeting time slot, determining 130 if the first participant can use a scheduled meeting time slot of the third participant, electronically exchanging 140 the scheduled meeting time slot of the first participant and the scheduled meeting time slot of the third participants, and electronically updating 150 an electronic calendar to reflect the electronic exchange of meeting time slots. As shown in FIG. 3, in some embodiments, determining step 110 further includes the step of providing 310 by the first participant a priority rating for at least one other meeting time slot. As shown in FIG. 4, in some embodiments, identifying step 120 includes the step of providing 420 by the third participant a priority rating for at least one other meeting time slot. As shown in FIG. 5, in some embodiments, determining step 110 further includes the step of requesting 510 by the first participant a new meeting time slot. As shown in FIG. 6, in some embodiments, determining step 110 further includes the step of identifying 610 a location of the first participant, wherein the location is a distance from a meeting location preventing the first participant from attending the meeting.

It may be appreciated that the herein invention relies on electronic calendars that are universally available. Typically this means something like Google Calendar (Google, Inc., Mountain View, Calif.) or some other electronic calendar that is available on the Internet or the cloud or on a common server or network.

At minimum, each listed meeting needs to include date, time and, of course, the participants. In a preferred embodiment, location may also be included, as will hereinafter be explained.

In a preferred embodiment, the user is having a meeting, for example, with some type of service provider. It could be a professional, like a lawyer, a doctor or an accountant. In other cases it could be a service provider, like a plumber, an electrician or an auto repairman. It may be appreciated that the underlying concept of the invention works with any type of meeting with any type of service provider.

The first step of the method is determining that a first participant has a need to change a scheduled meeting with a second participant. This could be for any number of reasons. There may be a schedule conflict. The user may be sick or out of town. There are a myriad of reasons why a person may not be able to attend a scheduled meeting, but, instead of canceling, he may want to simply attend at another time.

Sometimes, the user may want to exchange time slots because he can no longer cancel. For example, the service provider may have a 24 hour cancellation policy. Within that 24 hour period, the user learns he cannot make the appointment for whatever reason. Instead of canceling and paying a cancellation fee, he can exchange time slots with someone else.

In it its simplest embodiment, it could be as simple as the user went to get a coffee while waiting for his time slot at the car wash or motor vehicle bureau or for an oil change. Then, his turn was coming and he could not get back in time for his time slot. So, he seeks to switch with someone a little behind him in the queue.

There are any number of ways that the system can determine that there is a need to change a scheduled meeting. According to the herein method, this is done automatically according to empirical data that the system can identify and quantify.

One way of determining that a first participant has a need to change a scheduled meeting includes the first participant electronically issuing a notice that he needs to change the scheduled meeting. In other words, the participant sends some type of electronic notice to the system that he needs to change a scheduled meeting. Sometimes, he may send the notice to all the participants of the system.

Another way of determining that a first participant has a need to change the scheduled meeting includes monitoring an electronic calendar of the first participant. This involves monitoring each person's e-calendar. When a conflict occurs, the system automatically knows he has to change a scheduled meeting.

A conflict may not just be a time conflict but it could also be a location conflict. For example, the time slot is still available, but an earlier (or later) meeting is at a geographically distant location, so both meetings cannot be held, because there is no time to travel back and forth.

Still another way of determining that a first participant has a need to change the scheduled meeting includes monitoring a physical location of the first participant. What this means is that the physical location of the person is being continually monitored. If he is at a location that makes it physically impossible to attend the scheduled meeting, here too the system knows it has to change the scheduled meeting.

One common way to determine location is by determining a geographic location of a personal electronic device of the user. In some embodiments, geographic location is determined via a global positioning module. In some embodiments, the global positioning module includes at least one of “WIFI,” “Bluetooth,” “NFC” (Near Field Communication), “GPS” (Global Positioning System), “GLONASS” (Global Navigation Satellite System), mobile triangulation or similar technologies and applications.

Part of determining that a first participant needs to change a scheduled meeting includes determining an optimum date or time range for exchanging scheduled meetings. In other words, the user may specify that he wants his new meeting time slot to be on a certain day and/or at a certain time. As mentioned above, it could be as simple as wanting to change the time by a few minutes or an hour, but on the same day. Other times, he may need to postpone for several days of a week or a month. In some embodiments, the first participant defines the time for the new meeting in terms of priority rating. For example, the first participant may prefer that the new meeting be held during the rest of the week, rather than the week after, and much more than the week after that. Attempts to schedule the new meeting therefore seek to find new meeting time slots in that order.

The next step is identifying a third participant that can use the scheduled meeting with the second participant. In other words, the system finds someone else who is desirous of using that time slot with that other person. One example, would be somebody else has a meeting with that same doctor in two weeks, but would like to see the doctor sooner.

One manner of identifying a third participant that can use the scheduled meeting with the second participant includes the third participant electronically advising that he wants to change his scheduled meeting with the second participant. In other words, the other person specifically says he wants to exchange meetings.

Another way of identifying a third participant that can use the scheduled meeting with the second participant includes monitoring scheduling preferences of the third participant. There may be, for example, a built-in preference for trying to get an earlier meeting. In some embodiments, the third participant defines the time for a new meeting in terms of priority. For example, a third participant may prefer to reschedule the meeting for another day, but may also accept a same-day morning meeting and an early afternoon meeting, in that order, as discussed above.

The schedules of all participants are continuously monitored so that when a suitable opening becomes available, the first participant is immediately notified of that availability. In some embodiments, the priorities for various meeting time slots for all users of the system are continuously monitored in search for overlapping priorities. In some embodiments, once an overlap in priorities between the first participant and the third participant is identified, the meetings are switched. In some embodiments, all possible overlapping priorities are determined. In this embodiment, meeting switches may be resolved in a variety of ways. In some embodiments, the largest number of possible meeting switches is allowed to occur. By way of example, it is determined that three separate participants, participant A, B, and C, have set priorities to switch appointments at a dentist office. Participant A set a high priority for the time when participant B is scheduled and participant B set a high priority for the time when participant A is scheduled. However, participant B has also set a lower priority for when participant C is scheduled and participant C set a low priority for the time when participant A is scheduled. In this example, instead of switching the meetings of participants A and B because of the high priority of that switch and ignoring the switch request of participant C, the system recognizes the possibility of satisfying meeting switch requests for multiple participants and assigns participant C to the meeting time slow formerly held by participant A, assigns participant B to the meeting time slot formerly held by participant C, and assigns participant A to the meeting time slot formerly held by participant B. In some embodiments, exchanges between high priority matches are preferentially exchanged.

The system of the present disclosure therefore compiles, in some embodiments, the scheduled meeting information and meeting rescheduling priority information from a plurality of meeting participants and is capable of redistributing the meeting participants to optimize attendance by the meeting participants. The implementation of the concepts described herein on a computer system enables functionality heretofore impossible through manual scheduling. A participant's relative priorities for certain meetings slots, the ability to consider meeting slots across multiple service providers simultaneously, and the ability to quickly restructure schedules and alert the participants of that schedule restructuring contribute to a method that can be implemented on a time scale sufficiently short so that meeting switches can be implemented before the time for the meeting passes. Manually considering all of the data to effectively implement the functionality of the systems and methods of the present disclosure would be impractical as a scheduled meeting will likely have come and gone by the time a human determined that a meeting time slot exchange with another participant was available at that time. The system can also reschedule meetings even when the participants do not yet know that meetings need to be rescheduled. For instance, a participant is geographically too far away from a meeting location to make the scheduled meeting because weather conditions have made it so the participant cannot get there on time. Recognizing this situation, the system attempts to reschedule the first participant.

In some embodiments, the method involves determining if the first participant can use a scheduled meeting of the third participant with the second participant or with a person in a same group as the second participant. Before meeting time slots are exchanged, the user obviously first wants to make sure he can use the new meeting slot. If he cannot, then clearly he does not want to exchange.

In this regard, the third participant may have a scheduled meeting with the same person or with someone in the same group of participants or same category. For example, Moshe may have a meeting with Dr Yossi. If Reuven also has a meeting with Dr Yossi, then an exchange works as long as the time slots are open.

There may be occasions where Reuven does not have a meeting with Dr Yossi, but instead with Dr Dan. While Dr Dan is obviously a different person, he may still be the same type of doctor—they may both be dentists and possibly even in the same medical group. In that event, Moshe may still be willing to exchange because it is the same type of doctor even though the specific doctor is different.

Reuven may be scheduled with a certain car shop for an oil change and Shimon may be scheduled for an oil change at a different place. Both places are in the same group of participants, because both are auto oil change shops. In such event, Reuven may be willing to exchange appointments with Shimon.

In evaluating an exchange, according to the invention, the third participant may have his meeting with the same person or with someone who provides the same type of service.

Accordingly, the second participant and the person in the same group as the second participant are service providers and provide the same type of services.

Therefore, according to one aspect of the invention, identifying a third participant that can use the scheduled meeting with the second participant includes distributing an electronic notice to change a specified scheduled meeting with a designated service provider, and the third participant electronically advising that he is willing to exchange scheduled meetings.

One way of determining if the first participant can use the time slot or the scheduled meeting includes checking an electronic calendar of the first participant. This is the simplest procedure. If his calendar does not have this time slot open, then obviously the exchange cannot be made.

Another way of determining if the first participant can use the time slot or the scheduled meeting includes checking a physical location of the first participant. If he is at a location which makes it impossible to get to the new time slot on time, then obviously he cannot accept the exchange of time slots. Hence, the system determines if he is at a location that makes it possible for him to make the meeting in the new proposed time slot.

As described hereinabove, checking a physical location includes determining a physical location of an electronic device of the first participant. Checking a physical location may also include determining a location of the first participant based on entries in an electronic calendar.

Still another manner of determining if the first participant can use the time slot or the scheduled meeting includes the first participant electronically agreeing to exchange scheduled meetings. This obviously is the easiest way to confirm that an exchange can be made.

Further, another way of determining if the first participant can use the time slot or the scheduled meeting includes monitoring scheduling preferences of the first participant.

The next two steps involve electronically exchanging the scheduled meetings of the first and third participants and electronically updating the electronic calendar to reflect new scheduled meetings of the participants. According to a preferred embodiment, a central server or Internet website maintains the electronic calendar and facilitates selecting, arranging, or exchanging scheduled meetings. In other words, the system operates from the Internet or the cloud or a server and members can join the network and be part of the process.

An additional step may be to electronically advise service providers that participants have exchanged scheduled meetings. Service providers, like doctors, may need to know this information, so they know who to treat and to have the records ready and available.

In some cases, it may be desirable that the identities of the first and third participants be concealed from each other. There is no reason that either has to know the other. It is only necessary to know the time slot and service provider. If the service provider is a doctor or lawyer, for example, people may be sensitive and not want other people to know about it. Similarly, an identity of the first participant may be concealed from other participants. In some embodiments, the system of the present disclosure includes a security module that enables a participant to interact with and exchange meeting times with other participants without needing to provide identification information to the other participants. In some embodiments, the system of the present disclosure includes a security module that enables a participant to interact with and exchange meeting times with other participants without needing to provide identification information to the service provider.

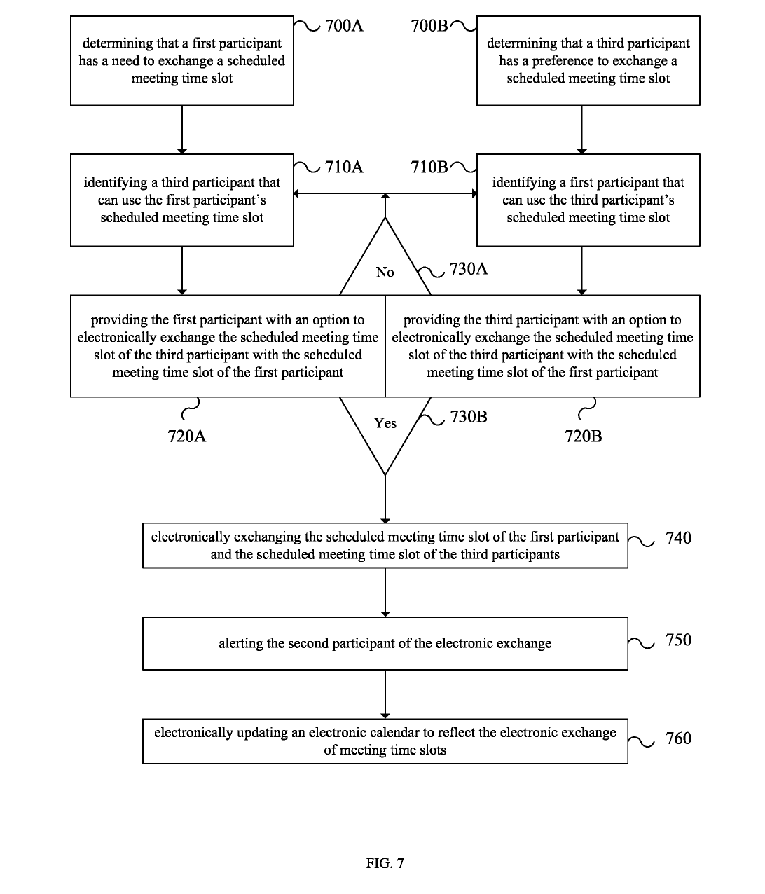

In some embodiments, the method of the present disclosure follows generally that portrayed in FIG. 7. Participants determine need 700A and preference 700B for exchanging meeting time slots. Participants then identify 710A and 710B other participants with which to change meeting time slots. If the participants cannot agree on the exchange 730A, the method reverts back to the identification steps 710A and 710B to identify new participants with which to exchange. In the participants do agree to exchange 730B, the method proceeds to electronically exchange 740 the meeting time slots between the participants. In some embodiments, the service provider is alerted 750 of the exchange. In some embodiments, electronic calendars are exchanged 760 to reflect the exchange.

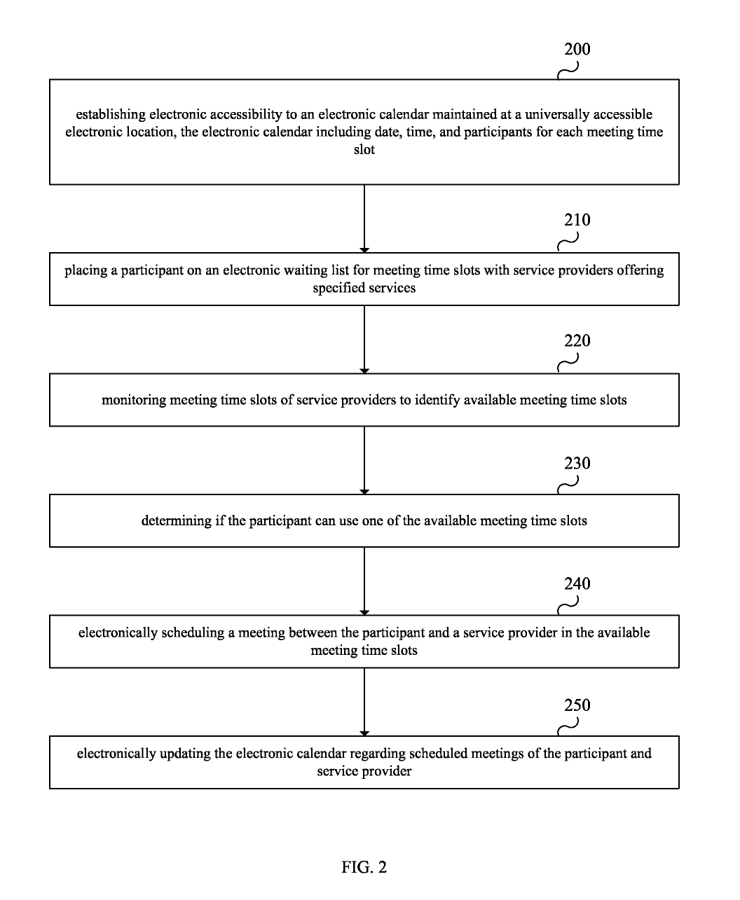

According to an alternate embodiment, the method may also be used to create an electronic waiting list, whereby a time slot is automatically and immediately booked once it is available and determined suitable for the user. As shown in FIG. 2, in some embodiments, the present disclosure is directed to an electronic method for scheduling meeting time slots, comprising the steps of, establishing 200 electronic accessibility to an electronic calendar maintained at an universally accessible electronic location, the electronic calendar including date, time, and participants for each meeting time slot, placing 210 a participant on an electronic waiting list for meeting time slots with service providers offering specified services, monitoring 220 meeting time slots of service providers to identify available meeting time slots, determining 230 if the participant can use one of the available meeting time slots, electronically scheduling 240 a meeting between the participant and a service provider in the available meeting time slots, and electronically updating 250 the electronic calendar regarding scheduled meetings of the participant and service provider.

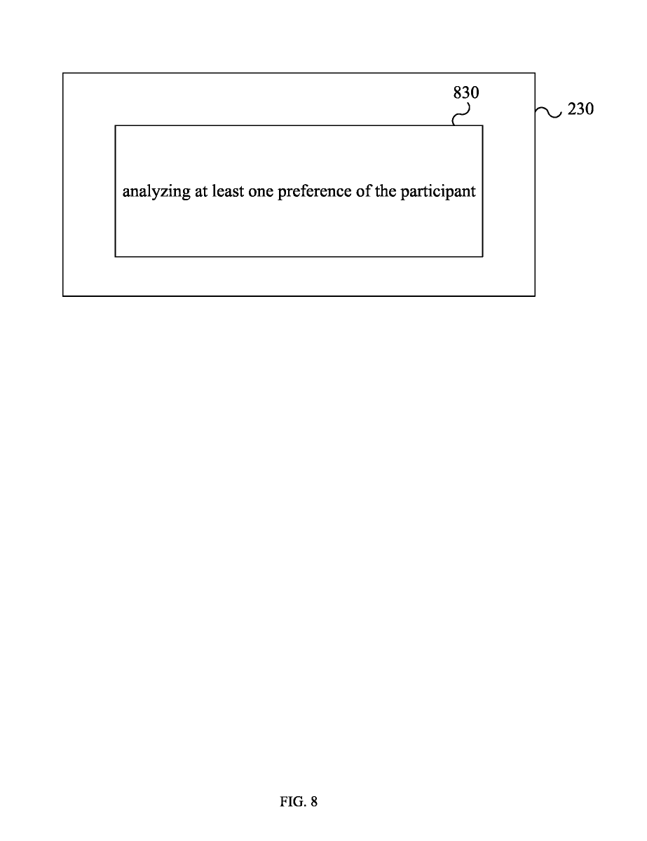

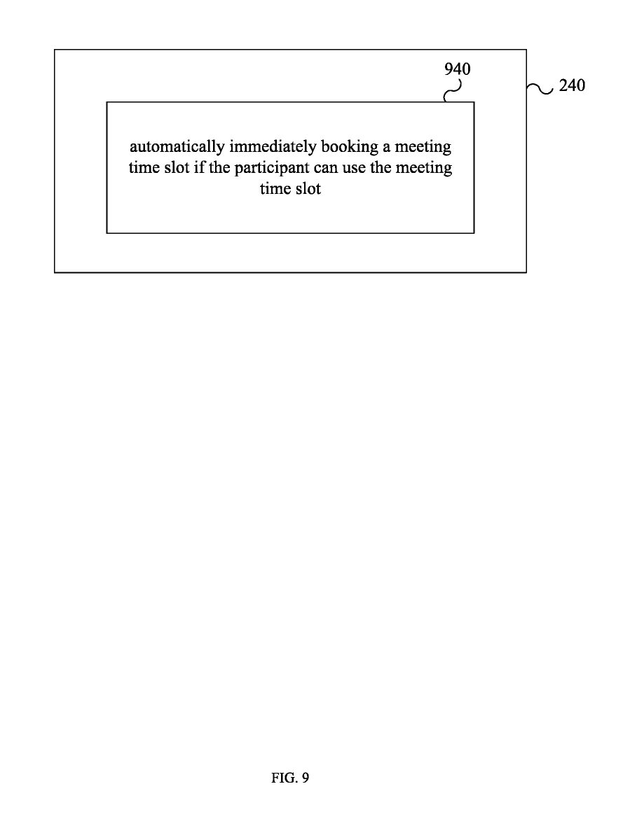

As shown in FIG. 8, in some embodiments, determining step 230 includes the step of analyzing 830 at least one preference of the participant. Preferably, determining if the participant can use one of the available time slots includes preferences of the participant. These preferences may include dates, times, days of the week, price, location, quality, recommendations, or past experiences. Further, as shown in one embodiment in FIG. 9, this method automatically and immediately books 940 a time slot if the participant can use the time slot.

The underlying concept of this invention may be utilized to place a person on a waiting list. Once it is determined that he needs to see a certain service provider, the system scans for an open time slot for this service provider or for another service provider who offers the same type of services. It needs to be appreciated that some service providers only make time slots available a certain amount of time in advance. For example, they may only make appointments a month in advance. Therefore, it can occur that a person needs a date for an appointment with his service provider, but there are no open time slots. In this scenario, the system will monitor the service provider's calendar. Once a time slot opens, it can be immediately and automatically booked for the user, assuming no scheduling conflicts. In this way, he does not lose the opportunity to book an open time slot at the earliest possible moment.

Similarly, to give the user flexibility, the system also monitors time slots of other service providers who offer the same services. In this way, the user gets the benefit of an appointment with whichever service provider first has an open time slot, even though it may develop that it is not his usual service provider.

According to a preferred embodiment, the electronic method of determining appointment dates includes:

establishing electronic accessibility to an electronic calendar maintained at a universally accessible electronic location, the electronic calendar including date, time, service provider and participants for each scheduled meeting;

determining that a participant has a need for specified services;

identifying the participant's usual service provider for the specified services;

determining that a participant has a need to arrange a meeting with the usual service provider for the specified services;

placing the participant on an electronic waiting list for the usual service provider or for a second service provider offering the specified services;

monitoring time slots of the usual service provider or the second service provider to determine when time slots become available;

identifying available open time slots for the usual service provider or for the second service provider;

determining if the participant can use the available time slot of the usual service provider or the available time slot of the second service provider;

determining if the available time slot of the usual service provider or the available time slot of the second service provider is more suitable for the participant;

electronically scheduling a meeting between the participant and the usual service provider in the available time slot of the usual service provider or electronically scheduling a meeting between the participant and the second service provider in the available time slot of the second service provider; and

electronically updating the electronic calendar regarding scheduled meetings of the participant and the service providers.

As explained above, there are a number of ways to determine when a person needs to see a service provider. He may have a toothache, so he needs a dentist. His car may be due for an oil change or a 50,000 mile service.

First, the system identifies if the person has a usual service provider for this service. Who is his dentist? Which auto repair center does he use? Open time slots for his usual service provider are identified. At the same time, the system searches for other people who offer the same services. This could be a dentist or doctor in the same medical group, or another dentist or doctor in an entirely different medical group. The other auto repair center may be one he has used previously, but is not his usual one.

In this way, the system can find the earliest open time slots for not just the usual service provider, but also for alternative service providers who offer the same services. This way the user has the benefit and possibility of using the alternative service provider if the alternative has an earlier open time slot.

For example, the user has a toothache. His usual dentist is not available until Sunday, but today is Tuesday. Another dentist may be available, however, on Wednesday or Thursday. Then, the system has to evaluate the open time slots. One may not be geographically convenient, even though it is earlier. It could also be that the user had a bad experience with the alternate service provider. Other issues could be price and/or reputation or insurance coverage. Once the determination is made as to which time lot is better, the appointment is made and the electronic calendars of the concerned persons are updated.

According to a variant of this method, the user is placed on a waiting list for just his usual service provider. In this case, when a time slot opens, it is evaluated. If the user can utilize this time slot, the appointment is made. In the event it cannot be used, then the search may be expanded to include other service providers as well.

This electronic method of determining appointment dates includes:

establishing electronic accessibility to an electronic calendar maintained at a universally accessible electronic location, said electronic calendar including date, time, service provider and participants for each scheduled meeting;

determining that a participant has a need for specified services;

identifying the participant's usual service provider for the specified services;

determining that a participant has a need to arrange a meeting with the usual service provider for the specified services;

placing the participant on an electronic waiting list for a time slot for the usual service provider;

identifying an available open time slot for the usual service provider;

determining if the participant can use the available time slot of the usual service provider; and

electronically updating the electronic calendar regarding scheduled meetings of the participant and service providers

If the available time slot is useable for the participant, electronically scheduling a meeting between the participant and the usual service provider in the available time slot of the usual service provider. If the available time slot is not useable for the participant, continuing the participant on the electronic waiting list for a time slot for the usual service provider; and

In this scenario, if there is not a suitable open time slot, the system may expand the search and include other service providers of the same type of services. Therefore, if the available time slot is not useable for the participant, the system may further include:

identifying a second available open time slot for the usual service provider or identifying a second service provider offering the specified services and having an available time slot;

determining if the participant can use the second available time slot of the usual service provider or the available time slot of the second service provider;

determining if the second available time slot of the usual service provider or the available time slot of the second service provider is more suitable for the participant; and

electronically scheduling a meeting between the participant and the usual service provider in the second available time slot of the usual service provider or electronically scheduling a meeting between the participant and the second service provider in the available time slot of the second service provider.

Further, this invention could even cover a situation where a time slot is being auctioned or sold. The herein inventive concept contemplates the time slot becoming available, but it is not pertinent to the herein invention as to how the time slot becomes available. It could be through cancellation, through swapping or trading, through auctioning or sale, or simply that the service provider is now making those dates available for appointments. In some embodiments, the system of the present invention comprises an electronic meeting time slot auction house. The auction house enables a participant to buy and sell meeting time slots, as well as to see which meetings time slots are available for purchase. The manual buying and selling of available meeting time slots is impractical, as the time sensitive nature of the time slots means that the lot posting, auction period, fund exchange, and then physical transfer of the time slot would more often than not only conclude after the meeting had passed.

It will be evident to those skilled in the art that the invention is not limited to the details of the foregoing illustrative embodiments and that the present invention may be embodied in other specific forms without departing from the spirit or essential attributes thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

What is claimed is:

1. An electronic method of exchanging meeting time slots, comprising the steps of:
establishing electronic accessibility to an electronic calendar maintained at an universally accessible electronic location, said electronic calendar including date, time, and participants for each meeting time slot, wherein each of a plurality of first participants and each of a plurality of third participants have scheduled meeting time slots with at least one second participant;
determining that a first participant has a need to exchange a scheduled meeting time slot;
identifying a third participant that can use said first participant's scheduled meeting time slot;
determining if said first participant can use a scheduled meeting time slot of said third participant;
electronically exchanging said scheduled meeting time slot of said first participant and said scheduled meeting time slot of said third participants; and
electronically updating an electronic calendar to reflect said electronic exchange of meeting time slots.

2. The electronic method of exchanging meeting time slots according to claim 1, wherein the step of determining a first participant has a need to exchange a meeting time slot includes the following step:
providing by said first participant a priority rating for at least one other meeting time slot.

3. The electronic method of exchanging meeting time slots according to claim 1, wherein the step of identifying a third participant that can use said first participant's scheduled meeting time slot includes the following step:
providing by said third participant a priority rating for at least one other meeting time slot.

4. The electronic method according to claim 1, wherein said second participant is a plurality of service providers providing the same type of services.

5. The method according to claim 1, wherein the step of determining that a first participant has a need to exchange a scheduled meeting time slot includes the step of:
requesting by said first participant a new meeting time slot.

6. The method according to claim 1, wherein the step of determining that a first participant has a need to exchange a scheduled meeting time slot includes the step of:
identifying a location of said first participant, wherein said location is a distance from a meeting location preventing said first participant from attending said meeting.

7. The method according to claim 6, wherein said location is determined by at least one of a global positioning module and entries in the electronic calendar of said first participant.

8. The method according to claim 1, further comprising the step of providing said third participant with an option to electronically exchange said scheduled meeting time slot of said third participant with said scheduled meeting time slot of said first participant.

9. The method according to claim 1, further comprising the step of providing said first participant with an option to electronically exchange said scheduled meeting time slot of said third participant with said scheduled meeting time slot of said first participant.

10. The method according to claim 1, further comprising the step of alerting said second participant of said electronic exchange.

11. The method according to claim 1, further comprising the step of providing a security module that enables a participant to interact with and exchange scheduled meeting time slots with other participants without providing identification information to said other participants.

12. An electronic method for scheduling meeting time slots, comprising the steps of:
establishing electronic accessibility to an electronic calendar maintained at a universally accessible electronic location, said electronic calendar including date, time, and participants for each meeting time slot;
placing a participant on an electronic waiting list for meeting time slots with service providers offering specified services;
monitoring meeting time slots of service providers to identify available meeting time slots;
determining if said participant can use one of said available meeting time slots;
electronically scheduling a meeting between said participant and a service provider in said available meeting time slots; and
electronically updating said electronic calendar regarding scheduled meetings of said participant and service provider.

13. The method according to claim 12, wherein the step of determining if said participant can use one of said available meeting time slots includes the step of:
analyzing at least one preference of said participant.

14. The method according to claim 13 wherein said at least one preference includes dates, times, days of the week, price, location, service quality, recommendations, or past experiences.

15. The method according to claim 12, wherein the step of electronically scheduling a meeting between said participant and a service provider in said available meeting time slots includes the step of:
automatically immediately booking a meeting time slot if said participant can use said meeting time slot.
